(19) United States
(12) Patent Application Publication
(10) Pub. No.: US 2012/0144110 A1
(43) Pub. Date: Jun. 7, 2012

(54) METHODS AND STRUCTURE FOR STORAGE MIGRATION USING STORAGE ARRAY MANAGED SERVER AGENTS

(75) Inventor: Hubbert Smith, Sandy, UT (US)

(73) Assignee: LSI CORPORATION, Milpitas, CA (US)

(21) Appl. No.: 12/959,230

(22) Filed: Dec. 2, 2010

(51) Int. Cl. G06F 12/00; G06F 12/02

(52) U.S. Cl. 711/114; 711/E12.001; 711/E12.002

(57) ABSTRACT

Methods and structure for improved migration of a logical volume storage migration using storage array managed server agents. Features and aspects hereof provide for a storage array (e.g., a RAID or other storage controller in a storage array) to manage the migration of a logical volume from a first physical storage volume to a second physical storage volume. The storage array cooperates with a server agent in each server configured to utilize the logical volume. The server agent provides a level of “virtualization” to map the logical volume to corresponding physical storage locations of a physical storage volume. The storage array exchanges information with the server agents such that the migration is performed by the storage array. Upon completion of the migration, the storage array notifies the server agents to modify their mapping information to remap the logical volume to a new physical storage volume.

### BACKGROUND

1. Field of the Invention

The invention relates generally to data migration in storage systems and more specifically relates to methods and structures for storage array management of data migration in cooperation with server agents.

2. Discussion of Related Art

Storage systems have evolved beyond simplistic, single storage devices configured and operated solely by host system based management of volumes. Present day storage systems incorporate local intelligence for redundancy and performance enhancements (e.g., RAID management). Logical volume (e.g., logical units or LUNs) are defined within the storage system and mapped to physical storage locations by operation of the storage controller of the storage system. The logical to physical mapping allows the physical distribution of stored data to be organized in ways that improve reliability (e.g., adding redundancy information) and to improve performance (e.g., striping of data). These management techniques hide much of the information regarding the physical layout/geometry of logical volumes from the attached host systems. Rather, the storage system controller maps logical addresses onto physical storage locations of one or more physical storage devices of the storage system. Still further management features of the storage system may provide complete virtualization of logical volumes under management control of the storage system and/or storage appliances. As above, the virtualization services of a storage system hide still further information regarding the mapping of logical volumes for corresponding physical storage devices.

From time to time, older storage system hardware (e.g., controllers and/or storage devices) must be retired and enterprise data migration is mandatory to move stored logical volumes to new storage system hardware (e.g., to redefine the logical volumes under control of a new controller and/or to physically migrate data from older storage devices to newer storage devices). If a logical volume is simply moved within a storage system (e.g., within a RAID storage system under control of the same RAID controller), there may be no need to even inform the attached servers of the migration process. Rather, the migration of a logical volume within the same storage system such that addresses to utilize the logical volume remain unchanged does not require any reconfiguration of a typical server system coupled to the storage system. By contrast, where a logical volume is migrated to a different storage array that must be accessed by a different address, the server needs to be aware of the migration so that it may properly address the correct storage array or system to access the logical volume after migration.

Migration of the data of logical volumes between different storage arrays/systems is difficult for server computers to perform because servers attached to present day storage systems do not have adequate information to perform data migration. The present physical organization of data on logical volumes of a storage system may be substantially, if not totally, hidden from the server computers coupled with a storage system. Relying on servers to migrate data often incurs substantial down time and gives rise to numerous post-migration application problems. As a server migrates data from one volume to another, the server typically has to take the volume off line so that I/O requests by that server or other servers are precluded. This off line status can last quite some time since the migration data copying can involve massive amounts of data. Further, post-migration, the administrative user of the server performing the migration has to manually update all security information for the migrated volume (e.g., Access Control Lists or ACLs), update network addressing information, mount points (i.e., local names used for the logical volume within the server so as to map to the new physical location of the volume), etc. Migration of data relying on the server computers is therefore generally a complex manual procedure with high risk for data loss and usually incurring substantial “down time” during which stored data may be unavailable. Virtualized storage systems hide even more information from the servers regarding physical organization of stored data. In addition, often dozens of application programs depend on the data on logical volumes thus multiplying the risk and business impact of such manual migration processes. In addition, migration is further complicated by the fact that the firmware (control logic) within many storage systems (e.g., providing RAID managed volumes) was designed for data protection, error handling, and storage protocols and thus provides little or no assistance to an administrative user charged with performing the manual migration processing.

Manual data migration involves in-house experts or consultants (i.e., skilled administrative users) who manually capture partition definitions, logical volume definitions, addressing information regarding defined logical volumes, etc. The administrator then initiates “down time” for the logical volume/volumes to be migrated, moves data as required for the migration, re-establishes connections to appropriate servers, and hopes the testing goes well.

Host based automated or semi-automated migration is unworkable because it lacks a usable view of the underlying storage configuration (e.g., lacks knowledge of the hidden information used by the management and/or virtualization services within the storage system). Manual migration usually involves taking dozens of applications off line, moving data wholesale to another storage array (e.g., to another logical volume), then bringing the applications back on line and hoping nothing breaks.

Some storage appliances provide capabilities for data migration. A “storage appliance” is a device that physically and logically is coupled between server systems and the underlying storage arrays to provide various storage management services. Often such appliances perform RAID level management of the underlying storage devices of the storage system and/or provide other forms of storage virtualization for the underlying physical storage devices of the storage system. Appliance based data migration is technically workable. LSI Corporation's Storage Virtualization Manager (SVM) and IBM's San Volume Controller (SVC) are exemplary storage appliances that both provide features for data migration. Such storage appliances create other problems in that, since the storage appliances manage meta-data associated with the logical volume definitions, once appliances are deployed they are difficult to extract because the stored meta-data in the appliance is critical to recovery or migration of the stored data but remains substantially or totally hidden from an administrative user. For that reason and other reasons, system administrators are in some cases reluctant to add the additional complexity, the added risk, the added expense, an additional point of failure, an additional device to upgrade/maintain. Thus, market acceptance of storage appliances is relatively poor compared to market expectations as storage appliances were developed. Acceptance of the added complexity (risk, expense, etc.) of storage appliances is prevalent primarily in very large enterprises where the added marginal costs, risks, etc. are relatively small.

Without the use of such storage appliances, there are no known storage array based migration capabilities. Rather, storage arrays are designed for different purposes utilizing special purpose hardware and firmware focused on data-protection, error handling, storage protocols, etc. Data migration tools within storage arrays have not been previously considered viable. Server based (e.g., manual) data migration and storage appliance based data migration solutions represent the present state of the art.

Thus it is an ongoing challenge to provide automated or semi-automated data migration in the absence of storage appliances designed to provide such features.

### SUMMARY

The present invention solves the above and other problems, thereby advancing the state of the useful arts, by providing methods and structure for a storage array (e.g., a RAID or other storage controller in a storage array) to manage the migration of a logical volume from a first physical storage volume to a second physical storage volume. The storage array cooperates with a server agent in each server configured to utilize the logical volume. The server agent provides a level of “virtualization” to map the logical volume to corresponding physical storage locations of a physical storage volume. The storage array exchanges information with the server agents such that the migration is performed by the storage array. Upon completion of the migration, the storage array notifies the server agents to modify their mapping information to remap the logical volume to a new physical storage volume.

In one aspect hereof, a system is provided comprising a first physical storage volume accessed using a first physical address and a second physical storage volume accessed at a second physical address. The system also comprises a first server coupled with the first and second physical storage volumes and adapted to generate I/O requests directed to a logical volume presently stored on the first physical storage volume. The system further comprises a first server agent operable on the first server. The first server agent adapted to map the logical volume to the first physical storage volume at the first physical address so that the I/O requests generated by the first server will access data on the first physical storage volume. The system still further comprises a first storage array coupled with the first server and coupled with the first server agent and coupled with the first physical storage volume and coupled with the second physical storage volume. The first storage array and the first server agent exchange information regarding migrating the logical volume to the second physical storage volume. The first storage array is adapted to migrate the logical volume from the first physical storage volume to the second physical storage volume while the system processes I/O requests directed from the first server to the logical volume. The first server agent is further adapted to modify its mapping to map the logical volume to the second physical storage volume at the second physical address following completion of migration so that the I/O requests generated by the first server will access data on the second physical storage volume at the second physical address.

Another aspect hereof provides a method and a computer readable medium embodying the method. The method operable in a system for migrating a logical volume among physical storage volumes. The system comprises a first server and a first server agent operable on the first server. The system further comprises a first storage array coupled with the first server agent. The method comprises mapping, by operation of the first server agent, a logical volume to a first physical storage volume at a first physical address and processing I/O requests directed to the logical volume from the first server. The method also comprises migrating, by operation of the first storage array, data of the logical volume to a second physical storage volume at a second physical address. The step of migrating is performed substantially concurrently with processing of the I/O requests. The method also comprises remapping, within the first server by operation of the first server agent, the logical volume to the second physical storage volume at the second physical address.

### BRIEF DESCRIPTION OF THE DRAWINGS

FIG. 1 is a block diagram of an exemplary system enhanced in accordance with features and aspects hereof to perform logical volume migration under control of a storage array of the system in cooperation with agents operable in each server configured to access the logical volume.

FIGS. 2, 3, and 4 are block diagrams of exemplary configurations of systems such as the system of FIG. 1 to provide improved logical volume migration in accordance with features and aspects hereof.

FIGS. 5, 6, and 7 are flowcharts describing exemplary methods to provide improved logical volume migration in accordance with features and aspects hereof.

FIG. 8 is a block diagram of a computer system that uses a computer readable medium to load programmed instructions for performing methods in accordance with features and aspects hereof to provide improved migration of a logical volume under control of a storage array of the system in cooperation with a server agent in each server configured to access the logical volume.

### DETAILED DESCRIPTION OF THE DRAWINGS

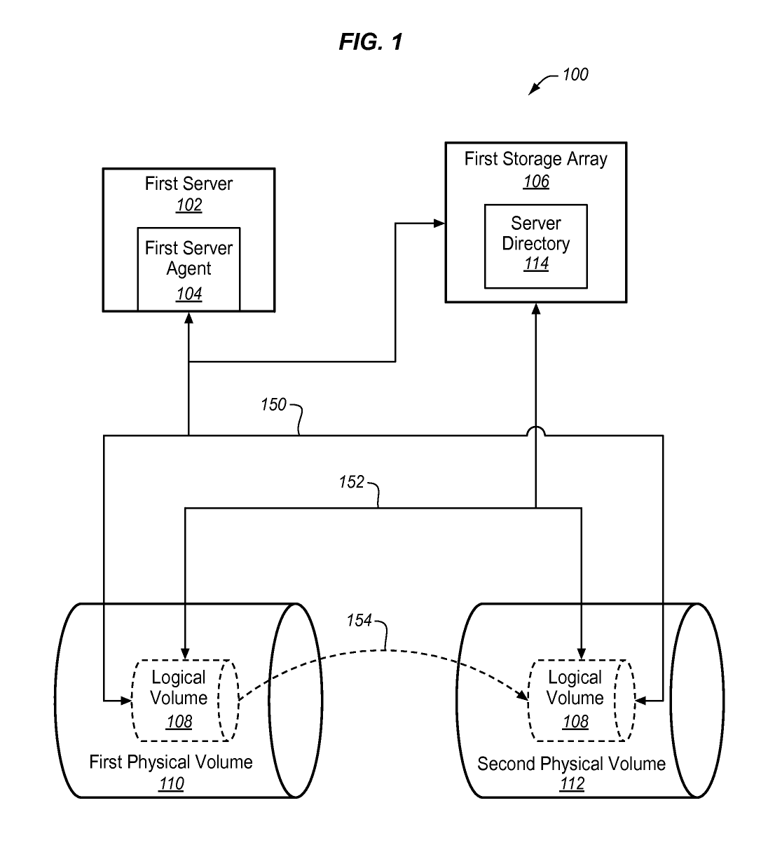

FIG. 1 is a block diagram of an exemplary system 100 enhanced in accordance with features and aspects hereof to provide improved migration of a logical volume 108 from a first physical storage volume 110 to a second physical storage volume 112. Each of first physical storage volume 110 and second physical storage volume 112 comprises one or more physical storage devices (e.g., magnetic or optical disk drives, solid-state devices, etc.). First server 102 of system 100 is coupled with first and second physical storage volumes 110 and 112 via path 150. First server 102 comprises any suitable computing device adapted to generate I/O requests directed to logical volume 108 stored on either volume 110 or 112. The I/O requests comprise read requests to retrieve data previously stored on the logical volume 108 and write requests to store supplied data on the persistent storage (i.e., physical storage devices) of the logical volume 108. Path 150 may be any of several well known, commercially available communication media and protocols including, for example, parallel or serial SCSI, Serial Advanced Technology Attachment (SATA), Fibre Channel (FC), etc.

First storage array 106 is also coupled with first server 102 via path 150 and comprises a storage controller adapted to manage one or more logical volumes. Such a storage controller of first storage array 106 may be any suitable computing device and/or customized logic circuits adapted for processing I/O requests directed to a logical volume under control of first storage array 106. First storage array 106 is coupled with both first physical storage volume and second physical storage volume via path 152. Path 152 may also utilize any of several well known commercially available communication media and protocols including, for example, parallel or serial SCSI, Serial Advanced Technology Attachment (SATA), Fibre Channel (FC), etc.

First physical storage volume 110 and second physical storage volume 112 may be physically arranged in a variety of configurations associated with first server 102 and/or with storage array 106 (as well as a variety of other configurations). Subsequent figures discussed further herein below present some exemplary embodiments where the first and second physical storage volumes 110 and 112 are integrated with other components of a system. For purposes of describing this FIG. 1, the physical location or integration of the first and second physical storage volumes 110 and 112 is not relevant. Thus, FIG. 1 is intended to describe any and all such physical configurations regardless of where the physical storage volume (110 and 112) reside. So long as first storage array 106 has communicative coupling with both physical storage volumes 110 and 112, first storage array 106 manages the migration process of logical volume 108 while first server 102 continues to generate I/O requests directed to logical volume 108.

Logical volume 108 comprises portions of one or more physical storage devices (i.e., storage devices of either first physical storage volume 110 or second physical storage volume 112). In particular, logical volume 108 comprises a plurality of storage blocks each identified by a corresponding logical block address. Each storage block is stored in some physical locations of the one or more physical storage devices at a corresponding physical block address. Logical block addresses of the logical volume 108 are mapped or translated into corresponding physical block addresses either on physical first physical storage volume 110 or on second physical storage volume 112. As noted above, for any of various reasons, logical volume 108 as presently stored on first physical volume storage volume 110 may be migrated to physical storage devices on second physical storage volume 112. Such migration is indicated by dashed arrow line 154.

In accordance with features and aspects hereof, first server 102 further comprises a first server agent 104 specifically adapted to provide the logical to physical mapping of logical addresses of logical volume 108 onto physical address of physical storage devices of the current physical storage volume on which logical volume 108 resides. First storage array 106 is adapted to exchange information with first server agent 104 to coordinate the processing associated with migration of logical volume 108 from first physical storage volume 110 onto second physical storage volume 112. In particular, first storage array 106 exchanges information with first server agent 104 to permit first server agent 104 to re-map appropriate pointers and other data structures when the migration of the logical volume 108 is completed. The updated mapping information utilized by first server agent 104 redirects I/O requests for logical volume 108 to access physical addresses of physical storage devices of second physical storage volume 112. In addition, as the migration process proceeds under control of the first storage array 106, first server agent may journal or otherwise record write data associated with I/O write requests processed during the migration of logical volume 108 from first physical storage volume 110 onto second physical storage volume 112. Such journaled data represents information to be updated on the logical volume 108 following copying of data during the migration of data from first physical storage volume 110 to second physical storage volume 112. Such journaled data may be communicated from first server agent 104 to first storage array 106 to permit completion of the migration process by updating the copied, migrated data of logical volume 108 to reflect the modifications made by the journaled data retained by first server agent 104.

In one exemplary embodiment, first storage array 106 may maintain server directory 114 comprising, for example, a database used as a repository by first storage array 106 to record configuration information regarding one or more logical volumes and the one or more servers that may access each of the logical volumes. Server directory 114 information in server directory 114 may then be utilized by first storage array 106 to notify multiple server agents each operable in one of multiple servers. In some embodiments, the information in the server directory 114 may be essentially statically configured by an administrative user. In other embodiments, information in the server directory 114 may be dynamically discovered through cooperative exchanges with first server agent 104 operable within first server 102 (as well as other server agents operable in other servers). For example, when an administrative user directs first storage array 106 to perform a migration of logical volume 108 for the first time, first storage array 106 may interact with first server agent 104 to discover all servers that are configured to access logical volume 108. When logical volume 108 is migrated from first physical storage line 110 to second physical storage volume 112, first storage array 106 may utilize the information in server directory 114 to determine which servers need to receive updated information (through their respective server agents) to remap logical volume 108 to point at the new physical location on second physical storage volume 112. First storage array 106 then transmits required information and signals to the server agent of each server so identified from the server directory 114 information (e.g., first server agent 104 of the first server 102, etc.).

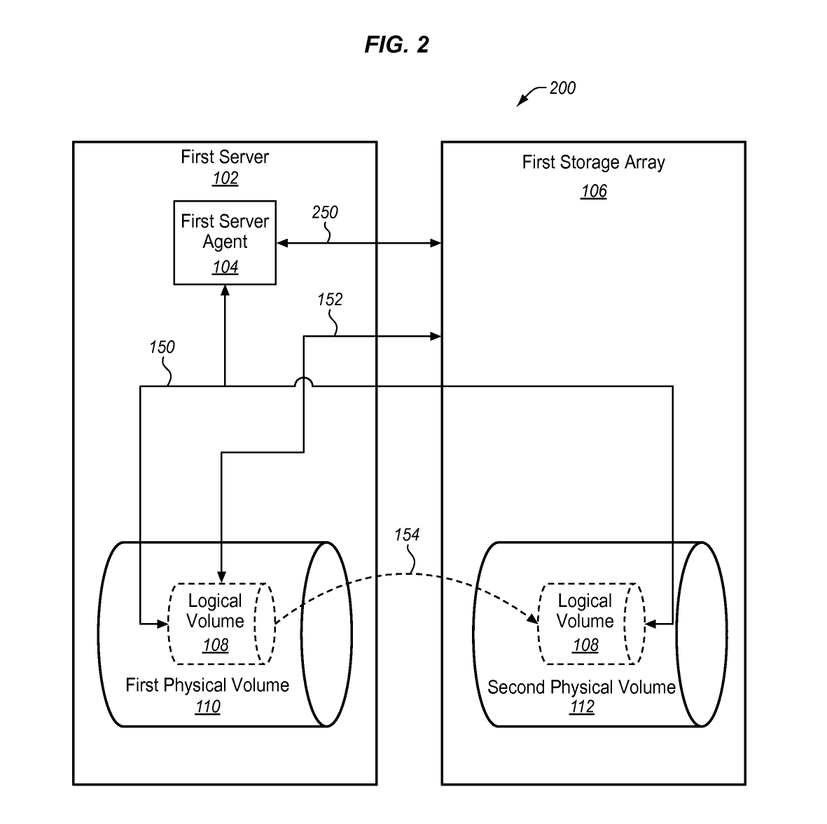

As noted above first storage array 106 controls migration processing to migrate logical volume 108 between the first physical storage volume 110 and second physical storage volume 112 regardless of where the physical storage volumes reside. FIG. 2 describes an exemplary system 200 in which first physical storage volume 110 physically resides within, and/or is directly coupled with, first server 102 (via path 150). Further, as shown in FIG. 2, second physical storage volume 112 physically resides within, and/or is directly coupled with, first storage array 106. In such a configuration, first storage array 106 migrates logical volume 108 from first physical storage volume 110 onto second physical storage volume 112 physically residing within and/or directly coupled to first storage array 106. First storage array 106 may be directly coupled with first physical storage volume 110 (via path 152) or, as shown in FIG. 2, may migrate logical volume 108 by reading the data therefrom via path 250 through first server agent 104 (operable within first server 102).

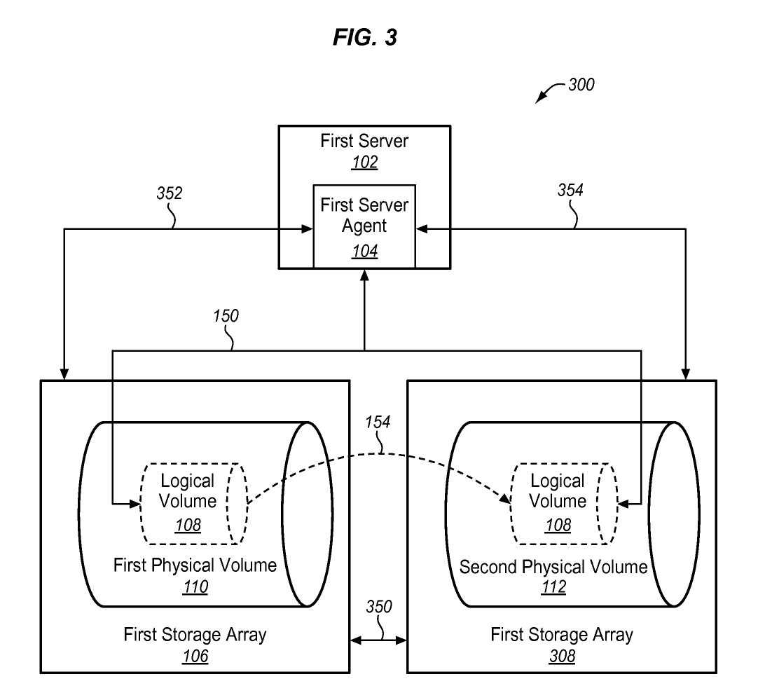

FIG. 3 describes another exemplary system 300 in which first physical storage volume 110 physically resides within, and/or is directly coupled with, first storage array 106 while the second physical storage volume 112 physically resides within, and/or is directly coupled with, second storage array 306. In such a configuration, first storage array 106 performs the migration of logical volume 108 from first physical storage volume 110 onto second physical storage volume 112. The copying of data in the migration process may be performed directly between first storage array 106 and second storage array 306 via a dedicated communication path 350. Communication path 350 may utilize any suitable communication medium and protocol including, for example, parallel or serial SCSI, Serial Advanced Technology Attachment (SATA), Infiniband, Fibre Channel, etc. In other exemplary embodiments, the data to be copied for migration of logical volume 108 may be exchanged between first storage array 106 and second storage array 306 via first server agent 104 as an intermediary coupled with both storage arrays (over paths 352 and 354).

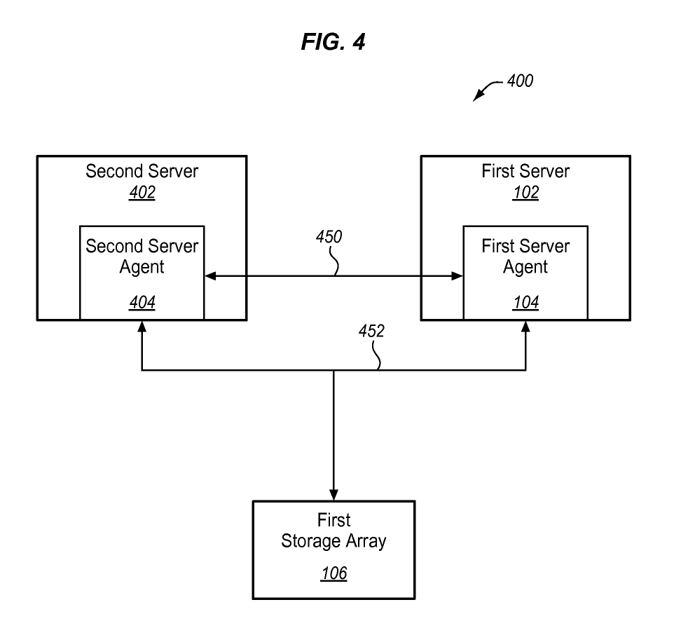

FIG. 4 is a block diagram of another exemplary system 400 configured such that first storage array 106 is coupled via path 452 with multiple servers (first server 102 and second server 402). In particular, first storage array 106 may be coupled via path 452 with first server agent 104 operable within first server 102 and may also be coupled via path 452 with the second server agent 404 operable within second server 402. In addition, or in the alternative, first server agent 104 may be communicatively coupled via path 450 with the second server agent 404 to permit first storage array 106 to communicate with either server agent by utilizing the other server agent as an intermediary in the communication path. Communication paths 450 and 452 may utilize any suitable communication medium and protocol including, for example, parallel or serial SCSI, Serial Advanced Technology Attachment (SATA), Infiniband, Fibre Channel, etc.

Those of ordinary skill in the art will readily recognize numerous equivalent configurations wherein first storage array 106 may perform the migration of logical volume 108 from first physical storage volume 110 onto second physical storage volume 112 regardless of where the physical storage volumes reside. In general, so long as first storage array 106 has some communication path coupling it with both the first physical storage volume and the second physical storage volume, any suitable configuration may be utilized in accordance with features and aspects hereof to improve the migration process. Those of ordinary skill in the art will also readily recognize numerous additional and equivalent elements that may be present in fully functional systems such as systems 100, 200, and 300 400 of FIGS. 1 through 4, respectively. Such additional and equivalent elements are omitted herein for simplicity and brevity of this discussion.

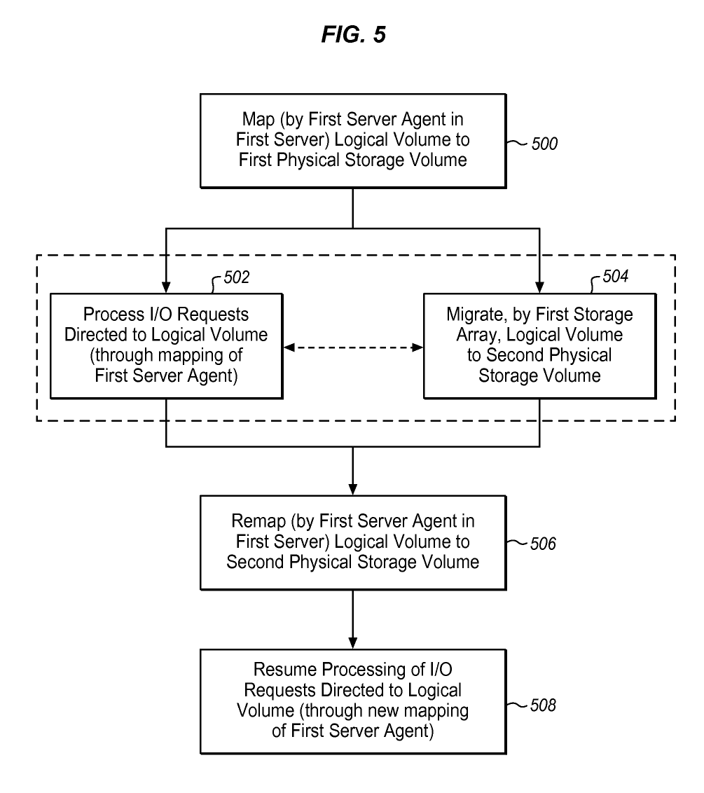

FIG. 5 is a flowchart describing an exemplary method in accordance with features and aspects hereof to improve the migration of a logical volume by operation of a storage array (i.e., by operation of an array controller in a storage array). The storage array is operable in conjunction with an agent operable on each server configured to utilize the logical volume. The migration process in accordance with features and aspects hereof is performed substantially automatically by the storage array while the underlying system concurrently continues to process I/O requests during the duration of the migration process. Step 500 represents the initial processing (e.g., “start of day” processing) in which the server agent operable in a server maps the logical volume to persistent storage locations on a first physical storage volume. In other words, step 500 represents the current configuration at startup wherein the logical volume is presently stored on a first physical storage volume. I/O requests may be processed in this initial configuration in accordance with normal operation of the servers and storage arrays coupled with the servers. The server agent operable in each of the servers utilizing the logical volume assures that the logical volume is presently mapped to storage locations on the first physical storage volume.

Responsive to administrative user input or some other detected event, steps 502 and 504 represent substantially concurrent processing to continue processing I/O requests while migrating the logical volume to another physical storage volume. At step 502, the system (e.g., one or more servers configured to utilize the logical volume) continues generating and processing I/O requests utilizing the currently configured logical to physical mapping by the server agent in each server. The mapping function provided by the server agent in each server directs the server's I/O requests for the logical volume onto the first physical storage volume where the logical volume is presently stored. Substantially concurrently, step 504 a storage array communicatively coupled with both the first and second physical storage volumes performs the migration of logical volume from the first storage physical storage volume where the logical volume is presently stored to a second physical storage volume. The dashed line coupling steps 502 and 504 represents the exchange of information between the server agent and the storage array performing the migration. The information exchanged comprises information relating to the migration processing performed by the storage array and may further comprise information relating to remapping of the logical volume following completion of the migration process. When migration processing step 504 completes, step 506 remaps the logical volume to point to physical storage locations on the second physical storage volume. The server agent in each of the one or more servers performs the remapping of the logical volume responsive to information received from the storage array at completion of the migration processing. According to the newly mapped configuration, any further I/O requests directed to the logical volume will be redirected (due to the new mapping) to physical locations on the second physical storage volume. At step 508, processing of I/O requests continues or resumes utilizing the new mapping information configured by the server agent in each of the servers configured to access the logical volume.

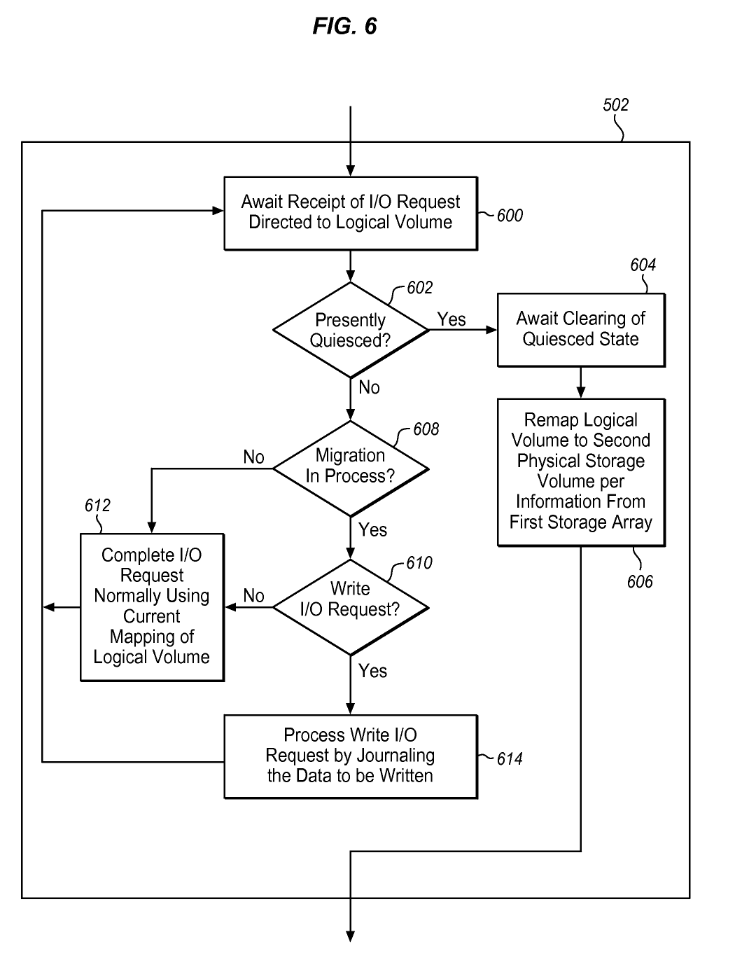

FIG. 6 is a flowchart describing exemplary additional details of the processing of step 502 of FIG. 5 to continue processing I/O requests directed to the logical volume while the logical volume is being migrated by operation of the storage array. Step 600 awaits receipt of a next I/O request directed to the logical volume. Upon receipt of a next I/O request, step 602 determines whether the storage array performing the migration processing has instructed the server (e.g., through the server agent) to quiesce its processing of new I/O requests. If so, step 604 awaits clearing of the requested quiesced state and step 606 remaps of the logical volume to point to the second physical storage volume in accordance with information received from the storage array performing the migration. As noted above, the server agent operable in each server utilizing the migrated logical volume may receive information from the storage array performing the migration indicating when the server should quiesce its processing and may receive mapping/remapping information regarding the new physical location of the logical volume following the migration process. Following processing of step 606, newly received I/O requests may be processed normally in accordance with the newly mapped logical volume now configured to direct I/O request to the second physical storage volume.

If step 602 determines that processing of I/O request is not presently quiesced, step 608 next determines whether the storage array has indicated that migration of the logical volume is presently in process. If not, step 612 completes processing of the I/O request normally using the currently defined mapping of the logical volume to some physical storage volume. Processing then continues looping back to the step 600 to await receipt of a next I/O request directed to the logical volume. If step 608 determines that the storage array is presently in process performing the migration of logical volume, step 610 next determines whether the newly received request is a write I/O request. If not, processing continues at step 612 as described above. Otherwise, step 614 processes the newly received write I/O request by journaling the data to be written. Since the storage array is in the process of migrating the logical volume data from a first physical storage volume to a second physical storage volume, changes to the logical volume as presently stored on the first physical storage volume may be journaled so that upon completion of the migration any further changes to the logical volume data may be entered into the second physical storage volume to which the logical volume has been migrated. Upon completion of journaling of the data associated with the newly received write I/O request, processing continues looping back to step 600 to await receipt of a next I/O request.

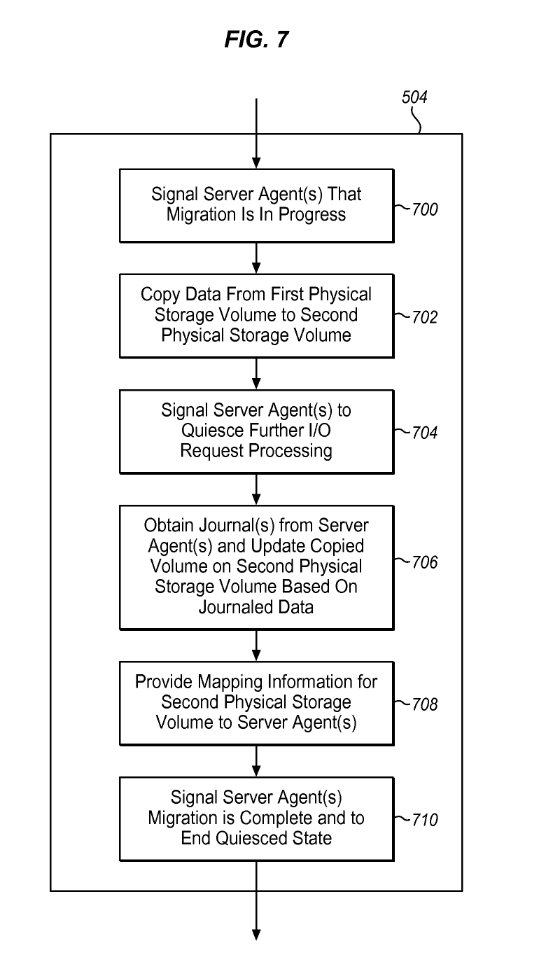

FIG. 7 is a flowchart describing exemplary additional details of the processing of step 504 of FIG. 5 to perform the migration of logical volume from a first physical storage volume to a second physical storage volume. At step 700, the storage array performing the migration signals the server agent in each server configured to access the logical volume that a migration is now in progress. At step 702, the logical volume as presently stored on the first physical storage volume is copied to the second physical storage volume. Upon completion of the copying of data, step 704 signals the server agent element in all servers configured to access the logical volume that they should enter a quiesced state to temporarily cease processing of new I/O requests directed to the logical volume as presently stored on the first physical storage volume. At step 706, the storage array retrieves all journaled data from the server agent element operable in each server configured to access the migrated logical volume. As noted above, while the migration is in process, the server agent element in each server configured to access the logical volume journals the data associated with any new write requests. The journaled data is then returned to the storage array performing the migration upon request by the storage array. At step 706, the storage array also updates the migrated logical volume data based on the journaled data to reflect any changes that may have occurred to the logical volume data while the migration copying was proceeding. At step 708, the storage array provides to the server agent element in each server configured to access the logical volume mapping information relating to the new mapping of the logical volume to the second physical storage volume. The new mapping information may then be utilized by each server agent to remap the logical volume to point to the second physical storage volume. At step 710, the storage array performing migration signals the server agent of each server configured to access the logical volume that the migration process has completed and that the quiesced state of each server may be ended. Each server then resumes normal processing of I/O requests in accordance with the remapped logical volume (now mapped to point at the second physical storage volume).

Still other features and aspects hereof provide for the storage array to exchange information with the server agents of multiple servers configured to utilize the logical volume directing the server agents to perform a “mock” failover of use of the logical volume. For example, where two (or more) servers are configured as redundant servers in accessing the logical volume, the storage array may direct the server agents to test the failover processing of access to the logical volume after the migration process to verify that the migrated volume is properly accessible to all such redundant servers. Still further, other exchanged information between the storage array performing the migration and the server agents of servers utilizing the logical volume may allow the storage array and/or the server agents to validate the migrated volume by testing the data and/or by comparing the migrated data with that of the original physical storage volume.

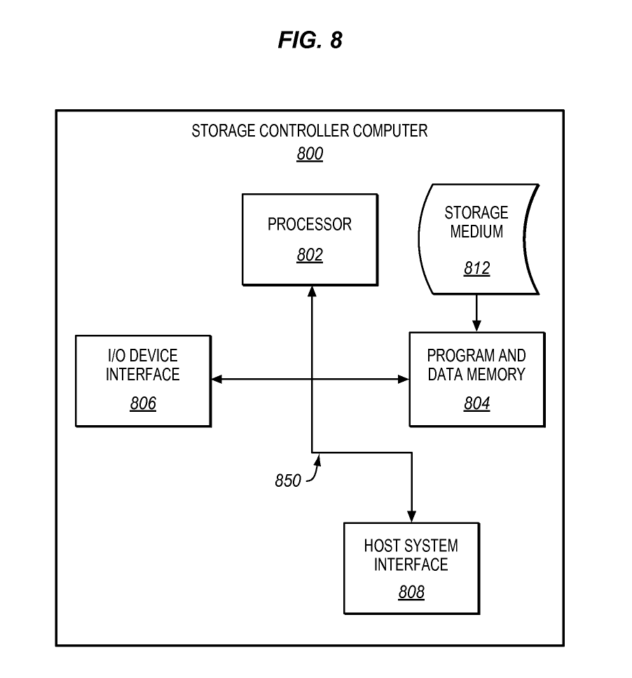

Embodiments of the invention can take the form of an entirely hardware (i.e., circuits) embodiment, an entirely software embodiment or an embodiment containing both hardware and software elements. In one embodiment, the invention is implemented in software, which includes but is not limited to firmware, resident software, microcode, etc. FIG. 8 is a block diagram depicting a storage system computer 800 adapted to provide features and aspects hereof by executing programmed instructions and accessing data stored on a computer readable storage medium 812. Computer 800 may be a computer such as embedded within the storage controller of a storage array that performs aspects of the logical volume migration in accordance with features and aspects hereof. In addition, computer 800 may be a server that incorporates a server agent in accordance with features and aspects hereof.

Furthermore, embodiments of the invention can take the form of a computer program product accessible from a computer-usable or computer-readable medium 812 providing program code for use by, or in connection with, a computer or any instruction execution system. For the purposes of this description, a computer-usable or computer readable medium can be any apparatus that can contain, store, communicate, propagate, or transport the program for use by or in connection with the computer, instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A storage system computer 800 suitable for storing and/or executing program code will include at least one processor 802 coupled directly or indirectly to memory elements 804 through a system bus 850. The memory elements 804 can include local memory employed during actual execution of the program code, bulk storage, and cache memories that provide temporary storage of at least some program code in order to reduce the number of times code must be retrieved from bulk storage during execution.

Input/output interface 806 couples the computer to I/O devices to be controlled (e.g., storage devices, etc.). Host system interface 808 may also couple the computer 800 to other data processing systems.

While the invention has been illustrated and described in the drawings and foregoing description, such illustration and description is to be considered as exemplary and not restrictive in character. One embodiment of the invention and minor variants thereof have been shown and described. In particular, features shown and described as exemplary software or firmware embodiments may be equivalently implemented as customized logic circuits and vice versa. Protection is desired for all changes and modifications that come within the spirit of the invention. Those skilled in the art will appreciate variations of the above-described embodiments that fall within the scope of the invention. As a result, the invention is not limited to the specific examples and illustrations discussed above, but only by the following claims and their equivalents.

What is claimed is:

1. A system comprising:
a first physical storage volume accessed using a first physical address;
a second physical storage volume accessed at a second physical address;
a first server coupled with the first and second physical storage volumes and adapted to generate I/O requests directed to a logical volume presently stored on the first physical storage volume;
a first server agent operable on the first server, the first server agent adapted to map the logical volume to the first physical storage volume at the first physical address so that the I/O requests generated by the first server will access data on the first physical storage volume; and
a first storage array coupled with the first server and coupled with the first server agent and coupled with the first physical storage volume and coupled with the second physical storage volume,
wherein the first storage array and the first server agent exchange information regarding migrating the logical volume to the second physical storage volume,
wherein the first storage array is adapted to migrate the logical volume from the first physical storage volume to the second physical storage volume while the system processes I/O requests directed from the first server to the logical volume, and
wherein the first server agent is further adapted to modify its mapping to map the logical volume to the second physical storage volume at the second physical address following completion of migration so that the I/O requests generated by the first server will access data on the second physical storage volume at the second physical address.

2. The system of claim 1
wherein the first physical storage volume comprises portions of one or more storage devices directly coupled to the server, and
wherein the second physical storage volume comprises portions of one or more storage devices of the first storage array.

3. The system of claim 1 further comprising:
a second storage array coupled with the first server and coupled with the first server agent,
wherein the first physical storage volume comprises portions of one or more storage devices of the first storage array, and
wherein the second physical storage volume comprises portions of one or more storage devices of the second storage array.

4. The system of claim 3
wherein the first storage array is communicatively coupled with the second storage array, and
wherein the first storage array is further adapted to exchange information with the second storage array, the exchanged information regarding migrating the logical volume to the second physical storage volume.

5. The system of claim 3
wherein the first storage array is adapted to exchange information with the second storage array through the first server agent, the exchanged information regarding migrating the logical volume to the second physical storage volume.

6. The system of claim 1 further comprising:
a second server adapted to generate I/O requests directed to the logical volume accessible by the second server; and
a second server agent operable on the second server, the second server agent communicatively coupled with the first storage array and with the first server agent, the second server agent adapted to map the logical volume to the first physical storage volume,
wherein the first server agent is further adapted to exchange information with the second server agent regarding the migration of the logical volume following completion of the migration, and
wherein the second server agent is further adapted to modify the mapping of the logical volume so that the I/O requests will access data on the second physical storage volume.

7. The system of claim 1 further comprising:
a second server adapted to generate I/O requests directed to the logical volume accessible by the second server; and
a second server agent operable on the second server, the second server agent communicatively coupled with the first storage array and with the first server agent, the second server agent adapted to map the logical volume to the first physical storage volume,
wherein the first storage array is further adapted to migrate the logical volume from the first physical storage volume to the second physical storage volume while the system processes I/O requests directed from the second server to the logical volume,
wherein the first storage array is further adapted to exchange information with the second server agent regarding the migration of the logical volume following completion of the migration, and
wherein the second server agent is further adapted to modify the mapping of the logical volume so that the I/O requests will access data on the second physical storage volume.

8. A method operable in a system for migrating a logical volume among physical storage volumes, the system comprising a first server and a first server agent operable on the first server, the system further comprising a first storage array coupled with the first server agent, the method comprising:
mapping, by operation of the first server agent, a logical volume to a first physical storage volume at a first physical address;
processing I/O requests directed to the logical volume from the first server;
migrating, by operation of the first storage array, data of the logical volume to a second physical storage volume at a second physical address, wherein the step of migrating is performed substantially concurrently with processing of the I/O requests; and
remapping, within the first server by operation of the first server agent, the logical volume to the second physical storage volume at the second physical address.

9. The method of claim 8
wherein the step of processing further comprises journaling, during the migration, changes to data on the first physical storage volume caused by processing of the I/O requests, and
wherein the step of migrating further comprises updating data on the second physical storage volume following completion of the migration based on the journaled changes to the data.

10. The method of claim 9
wherein the step of updating further comprises quiescing, by operation of the first server agent prior to updating, generation of I/O requests directed to the logical volume from the first server, and
wherein the step of remapping further comprises resuming, by operation of the first server agent following completion of the remapping, generation of I/O requests directed to the logical volume from the first server.

11. The method of claim 8
wherein the system further comprises a second server and a second server agent operable on the second server, the second server coupled with the first storage array, the second server agent adapted to map the logical volume to the first physical storage volume,
the method further comprising:
processing I/O requests directed to the logical volume from the second server, wherein the step of migrating is performed substantially concurrently with processing of the I/O requests from the second server;
exchanging information between the first storage array and the second server agent regarding the migration of the logical volume to the second physical storage volume; and
remapping, within the second server by operation of the second server agent, the logical volume to the second physical storage volume at the second physical address.

12. The method of claim 11
wherein the step of migrating further comprises:
journaling changes to data on the first physical storage volume during the migration caused by processing of the I/O requests; and
updating data on the second physical storage volume following completion of the migration based on the journaled changes to the data.

13. The method of claim 12
wherein the step of updating further comprises quiescing, by operation of the first server agent and the second server agent prior to updating, generation of I/O requests directed to the logical volume from the first server and from the second server, and
wherein the step of remapping further comprises resuming, by operation of the first server agent and the second server agent following completion of the remapping, generation of I/O requests directed to the logical volume from the first server and from the second server.

14. A computer readable medium embodying programmed instructions which, when executed by a computer, perform a method operable in a system for migrating a logical volume among physical storage volumes, the system comprising a first server and a first server agent operable on the first server, the system further comprising a first storage array coupled with the first server agent, the method comprising:
mapping, by operation of the first server agent, a logical volume to a first physical storage volume at a first physical address;
processing I/O requests directed to the logical volume from the first server;
migrating, by operation of the first storage array, data of the logical volume to a second physical storage volume at a second physical address, wherein the step of migrating is performed substantially concurrently with processing of the I/O requests; and
remapping, within the first server by operation of the first server agent, the logical volume to the second physical storage volume at the second physical address.

15. The medium of claim 14
wherein the step of processing further comprises journaling, during the migration, changes to data on the first physical storage volume caused by processing of the I/O requests, and
wherein the step of migrating further comprises updating data on the second physical storage volume following completion of the migration based on the journaled changes to the data.

16. The medium of claim 15
wherein the step of updating further comprises quiescing, by operation of the first server agent prior to updating, generation of I/O requests directed to the logical volume from the first server, and
wherein the step of remapping further comprises resuming, by operation of the first server agent following completion of the remapping, generation of I/O requests directed to the logical volume from the first server.

17. The medium of claim 14
wherein the system further comprises a second server and a second server agent operable on the second server, the second server coupled with the first storage array, the second server agent adapted to map the logical volume to the first physical storage volume,
the method further comprising:
processing I/O requests directed to the logical volume from the second server, wherein the step of migrating is performed substantially concurrently with processing of the I/O requests from the second server;
exchanging information between the first storage array and the second server agent regarding the migration of the logical volume to the second physical storage volume; and
remapping, within the second server by operation of the second server agent, the logical volume to the second physical storage volume at the second physical address.

18. The medium of claim 17
wherein the step of migrating further comprises:
journaling changes to data on the first physical storage volume during the migration caused by processing of the I/O requests; and
updating data on the second physical storage volume following completion of the migration based on the journaled changes to the data.

19. The medium of claim 18
wherein the step of updating further comprises quiescing, by operation of the first server agent and the second server agent prior to updating, generation of I/O requests directed to the logical volume from the first server and from the second server, and
wherein the step of remapping further comprises resuming, by operation of the first server agent and the second server agent following completion of the remapping, generation of I/O requests directed to the logical volume from the first server and from the second server.
